(19) United States
(12) Patent Application Publication
(10) Pub. No.: US 2026/0238561 A1
(43) Pub. Date: Aug. 13, 2026

(54) TECHNOLOGIES FOR MANAGING ARTIFICIAL INTELLIGENCE MODELS AND DATASETS

(71) Applicant: Apple Inc., Cupertino, CA (US)

(72) Inventors: Peng Cheng, Beijing (CN); Haijing Hu, Los Gatos, CA (US); Fangli Xu, Beijing (CN); Yuqin Chen, Beijing (CN); Ping-Heng Kuo, Greater London (GB); Naveen Kumar R. Palle Venkata, San Diego, CA (US); Ralf Rossbach, Munich, Bavaria-Bayern (DE); Alexander Sirotkin, Herzliya (IL)

(73) Assignee: Apple Inc., Cupertino, CA (US)

(21) Appl. No.: 19/471,652

(22) PCT Filed: Apr. 5, 2023
(86) PCT No.: PCT/CN2023/086361

§ 371 Date: Oct. 1, 2025

(51) Int. Cl. H04L 41/16; H04W 8/22; H04W 12/08

(52) U.S. Cl. CPC H04L 41/16; H04W 8/22; H04W 12/08

(57) ABSTRACT

The present application relates to devices and components including apparatus, systems, and methods for managing artificial intelligence models and datasets.

### FIELD

This application relates to wireless network and, more specifically, to technologies for managing artificial intelligence models and datasets within said networks.

### BACKGROUND

Third Generation Partnership Project (3GPP) Technical Specifications (TSs) define standards for wireless networks. These TSs describe aspects related to communications between nodes of a radio access network within these wireless networks.

### BRIEF DESCRIPTION OF THE DRAWINGS

FIG. 1 illustrates a network environment in accordance with some embodiments.

FIG. 2 illustrates an intelligence framework in accordance with some embodiments.

FIG. 3 illustrates a signaling procedure in accordance with some embodiments.

FIG. 4 illustrates another signaling procedure in accordance with some embodiments.

FIG. 5 illustrates another signaling procedure in accordance with some embodiments.

FIG. 6 illustrates another signaling procedure in accordance with some embodiments.

FIG. 7 illustrates messages in accordance with some embodiments.

FIG. 8 illustrates messages in accordance with some embodiments.

FIG. 9 illustrates an operational flow/algorithmic structure in accordance with some embodiments.

FIG. 10 illustrates another operational flow/algorithmic structure in accordance with some embodiments.

FIG. 11 illustrates another operational flow/algorithmic structure in accordance with some embodiments.

FIG. 12 illustrates a user equipment in accordance with some embodiments.

FIG. 13 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated.

Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

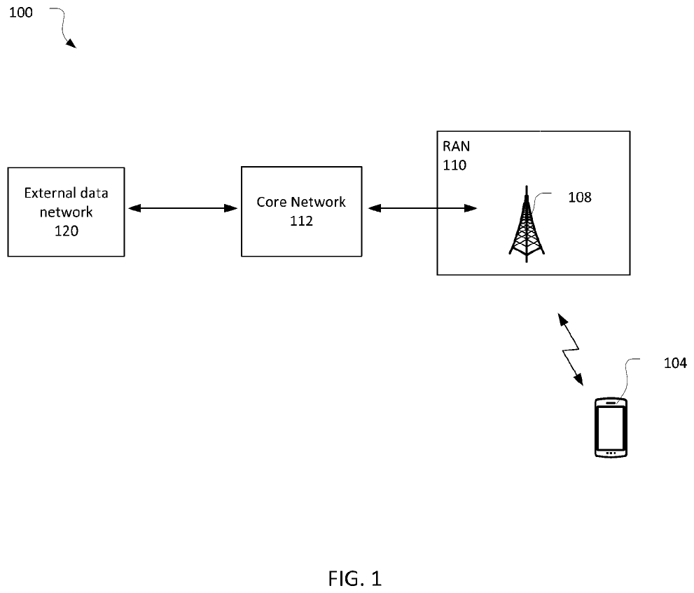

FIG. 1 illustrates a network environment 100 in accordance with some embodiments. The network environment 100 may include a user equipment (UE) 104 communicatively coupled with a base station 108 of a radio access network (RAN) 110. In some instances, the base station 108 may be a next generation (NG)-RAN node such as a gNB or an ng-eNB. The UE 104 and the base station 108 may communicate over air interfaces compatible with 3GPP TSs such as those that define a Fifth Generation (5G) new radio (NR) system or a later system (for example, a Sixth Generation (6G) radio system). The base station 108 may provide user plane and control plane protocol terminations toward the UE 104.

The network environment 100 may further include a core network 112. For example, the core network 112 may comprise a 5th generation core network (5GC) or later generation core network (for example, a 6th generation core network (6GC)). The core network 112 may be coupled to the base station 108 via a fiber optic or wireless backhaul.

The core network 112 may provide functions for the UEs 104 via the base station 108. These functions may include managing subscriber profile information, subscriber location, authentication of services, switching functions for voice and data sessions, and routing and forwarding of user plane packets between the RAN 110 and an external data network 120.

In some embodiments, one or more nodes of the network environment 100 may be used as an agent to train an AI model. An AI model, as used herein, may include a machine learning (ML) model, a neural network (NN), or a deep learning network.

In some embodiments, the AI model may be play a role in improving network functions. For example, an AI model may be trained by an AI agent in the network environment 100 and may be used to facilitate decisions made in the RAN 110 or the CN 112. These decisions may be related to beam management, positioning, resource allocation, network management (for example, operations, administration and maintenance (OAM) aspects), route selection, energy-saving, load-balancing, etc.

In some embodiments, the AI model may play a role in an AI-as-a-Service (AlaaS) platform. In an AlaaS platform, the AI services may be consumed by applications initiated at either a user level or a network level, and the service provider may be any AI agent reachable in the network environment 100.

In some embodiments, AI models may be employed for one or more use-case functions including, for example, channel state information (CSI) feedback enhancement, beam management, or positioning accuracy enhancement. Various protocol aspects may be developed to support these or other use-case functions While specific AI models may be left to implementation, various 3GPP TSs may be provide for protocol aspects relating to AI functionality over the air interface and user data privacy. The protocol aspects may include, for example, aspects related to capability indication, configuration and control procedures (for example, AI model training and inference), management of data, and management of AI models. AI operation for the air interface may be based on a current RAN architecture without requiring introduction of new interfaces.

AI models may be transferred between different entities of the network environment 100 according to one or more of the following examples. In a first example, the base station 108 may transfer or deliver AI model(s) to the UE 104 via radio resource control (RRC) signaling or user plane (UP) data. In a second example, a function of the core network 112 such as, for example, an OAM node, may transfer or deliver AI model(s) to the UE 104 via non-access stratum (NAS) signaling or UP data. In a third example, a location management function (LMF) of the core network 112 may transfer/deliver AI model(s) to the UE 104 via a positioning protocol (for example, a Long Term Evolution (LTE) positioning protocol (LPP)) or UP data. In a fourth example, a server of the external data network 120 may transfer/deliver AI model(s) to the UE 104 in a manner that is transparent to 3GPP network components.

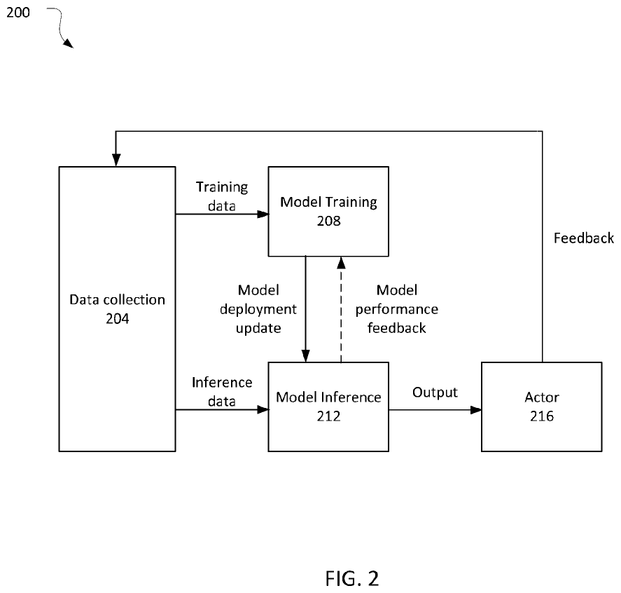

FIG. 2 illustrates an intelligence framework 200 that may be implemented by the network environment 100 in accordance with some embodiments. The intelligence framework 200 may include a data collection function 204 that collects a dataset that may be model training data or model inference data. The data may include, or be based on, radio-related measurements, application-related measurements, sensor input, feedback from an actor 216, etc. In some embodiments, the data collection 204 may be performed by components that have access to the air interface, e.g., the base station 108 or the UE 104. The dataset(s) collected by one of the components may be transferred to the other.

Data collection aspects may be different for different lifecycle management (LCM) functions, e.g., model training, model inference, model monitoring, or model activation/deactivation/selection/switch/update. For example, a relatively large data size and relatively loose latency may be used for offline training, while a relatively tight latency requirement may be used for model monitoring or inference. Data collection techniques with adequate security and UE privacy is also desired.

Embodiments of the present disclosure adapt various quality of experience (QoE) framework principles for purposes of data collection as will be described.

The intelligence framework 200 may include a model training function 208 that receives training data from the data collection function 204. The model training function 208 may be implemented by components of the network environment, e.g., an OAM node. The model training function 208 may use the training data to perform AI model training, validation, and testing. In some instances, the model training function 208 may perform data preparation (for example, data pre-processing and cleaning, formatting, or transformation) for a specific AI algorithm.

In one example, the model training function 208 may train an AI model by determining a plurality of weights that are to be used within layers of a neural network. For example, consider a neural network having an input layer with dimensions that match the dimensions of an input matrix constructed of the dataset. The neural network may include one or more hidden layers and an output layer having M×1 dimensions that outputs an M×1 codeword. Each of the layers of the neural network may have a different number of nodes, with each node connected with nodes of adjacent layers or nodes of non-adjacent layers. In general, at some layer(s), a node may generate an output as a non-linear function of a sum of its inputs, and provide the output to nodes of an adjacent layer through corresponding connections. A set of weights, which may also be referred to as the AI model in this example, may adjust the strength of connections between nodes of adjacent layers. The weights may be set based on a training process with training input (generated from the dataset) and desired outputs. The training data may be provided to the AI model and a difference between an output and the desired output may be used to adjust the weights. In other embodiments, the model training function 208 may train an AI model in other manners. For example, the UE 104 may use the training data to determine parameter values of an AI model such as a decision tree or simple linear function in other manners.

Upon training an AI model, the model training 208 may use a model deployment update to provide a trained, validated, tested, or updated AI model to a model inference function 212 of the intelligence framework 200. The model inference 212 may also receive inference data from the data collection 204 and generate output (for example, predictions or decisions). The output may be provided to an actor 216. The model inference function 212 may also provide model performance feedback to the model training function 208. In some instances, the model inference function 212 may perform data preparation (for example, data pre-processing and cleaning, formatting, or transformation) for a specific AI algorithm.

Unless otherwise described herein, the intelligence framework 200 may operate consistent with principles described in 3GPP Technical Report (TR) 37.817 v 17.0.0 (2022-04-06).

Embodiments of the present disclosure provide control plane solutions for managing AI models and datasets. Some embodiments describe various procedures including model identification; offline model training and dataset reporting; and online model training/inference/monitoring. The offline model training may be hosted and managed by an OAM node. The online training may include model training, model inference, and model monitoring procedures that may be hosted by the base station 108 or an LMF in the event a use-case function is associated with a relatively more stringent latency requirement.

Some embodiments provide for signaling aspects to support control plane solutions for managing AI models and datasets. A new signaling radio bearer (SRB) with a configurable priority may be used to include AI model(s), AI model dataset(s), or QoE dataset(s). Application layer segmentation may also be described for RRC messages carrying AI related information.

Some embodiments also provide for UE assistance information to provide signaling related to dynamic UE capabilities. For example, UE assistance information may be used to indicate a presence or absence of a temporary capability reduction at the UE 104.

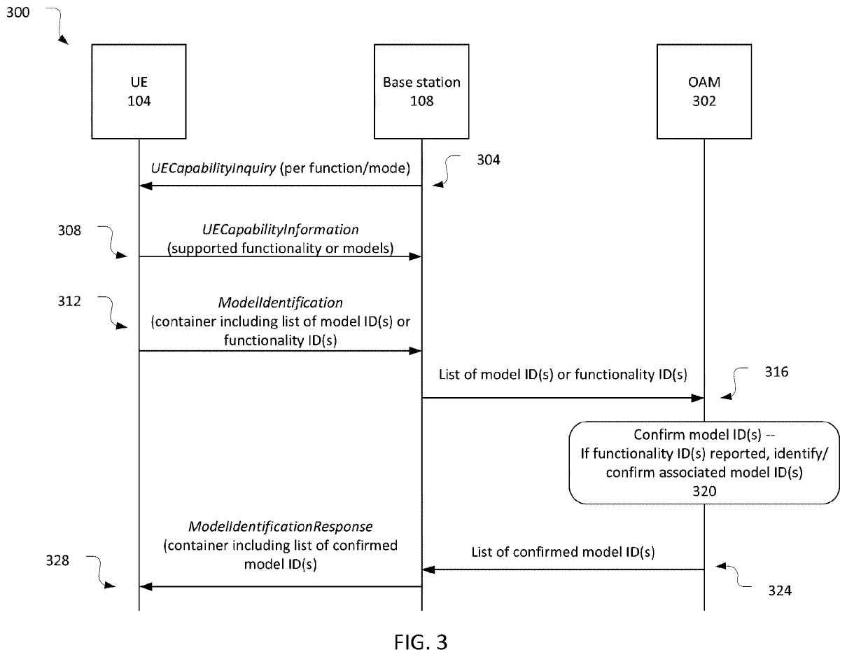

FIG. 3 illustrates a signaling procedure 300 that illustrates aspects of AI model identification and registration in accordance with some embodiments. The signaling procedure 300 may include signals between, and operations performed by, the UE 104, the base station 108, and an OAM 302. In some embodiments, some or all of the operations of the signaling procedure 300 that are performed by the base station 108 may be performed by a base station centralized unit (CU). The OAM 302 may be a node of the network environment 100.

The signaling procedure 300 may include capability reporting to convey access stratum (AS) capability information regarding AI models supported by the UE 104 to the base station 108. In particular, at 304, the signaling procedure 300 may include the base station 108 sending a UE capability inquiry (UECapabilityInquiry) message to the UE 104. The UECapabilityInquiry message may request reporting of AI models supported by the UE 104. The granularity of the requested capabilities may be per use-case function or per AI model. For example, a per-use case function granularity may request an indication of which AI models are supported for a given use-case function; and a per-model granularity may request an indication of which use-case functions are supported for a given AI model. The use-case functions may include, but are not limited to, CSI feedback enhancement, beam management, and positioning accuracy enhancement. The AI models may include, but are not limited to, a convolutional neural network (CNN) model, a recurrent neural network (RNN) model, or a reinforced learning model.

In response to receipt of the UECapabilityInquiry message, the UE 104 may send the base station 108 a UE capability information (UECapabilityInformation) message that includes a list of supported use-case functions or AI models. The UECapabilityInformation message may include the UE capability information with a requested granularity of, for example, per use-case function or per AI model.

In some embodiments, the UECapabilityInquiry message may not designate a specific granularity. In these embodiments, the UE 104 may generate the UECapabilityInformation message in a manner determined appropriate by the UE 104.

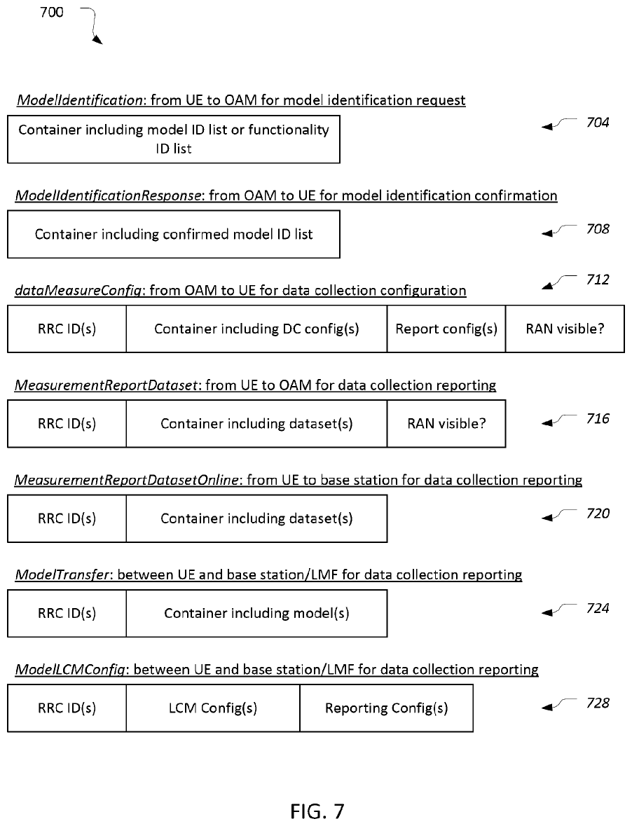

The signaling procedure 300 may further include the UE 104 transmitting a model identification (ModelIdentification) message at 312. The ModelIdentification message may be transmitted to the OAM 302 via the base station 108 in order to determine whether the OAM 302 is capable of training identified AI models. The ModelIdentification message may be a new RRC message that includes a container with model ID(s) respectively associated with AI model(s) or functionality ID(s) respectively associated with use-case function(s) supported by the UE 104. The container may include model/functionality ID(s) that may be used by the UE 104 but are not supported by the base station 108. The ModelIdentification message may be similar to ModelIdentification 704 shown in the RRC messages 700 of FIG. 7 in accordance with some embodiments.

The model/functionality ID(s) may be global identifiers pre-assigned by a manufacturer or serving public land mobile network (PLMN). The ID(s) may be unique across PLMNs and vendors.

In some embodiments, one functionality ID may be associated with one or more model IDs.

Upon receiving the ModelIdentification message, the base station 108 may access the list of model/functionality ID(s) from the container and forward the list to the OAM 302 at 316. In some embodiments, instead of accessing the list of model/functionality ID(s) from the container, the base station 108 may transparently forward the container itself.

At 320, the OAM 302 may confirm model ID(s). In confirming the model ID, the OAM 302 may determine that the corresponding AI model is supported by the network. For example, the AI model may be obtained by the OAM 302 and trained by the OAM 302 or other components in an offline or online manner as described elsewhere herein. In the event functionality ID(s) are reported, the OAM may identify model ID(s) associated with the reported functionality ID(s) and confirm those model ID(s).

At 324, the OAM 302 may transmit a list of confirmed model ID(s) to the base station 108. The base station 108 may generate a container with the list of confirmed model ID(s) and send the container to the UE 104 in a new RRC message, for example, a model identification response (ModelIdentificationResponse) message, at 328. In some embodiments, the OAM 302 may generate the container with the list of confirmed model ID(s) and the base station 108 may transparently forward the container to the UE 104. The ModelIdentificationResponse message may be similar to ModelIdentificationResponse 708 shown in the RRC messages 700 of FIG. 7 in accordance with some embodiments.

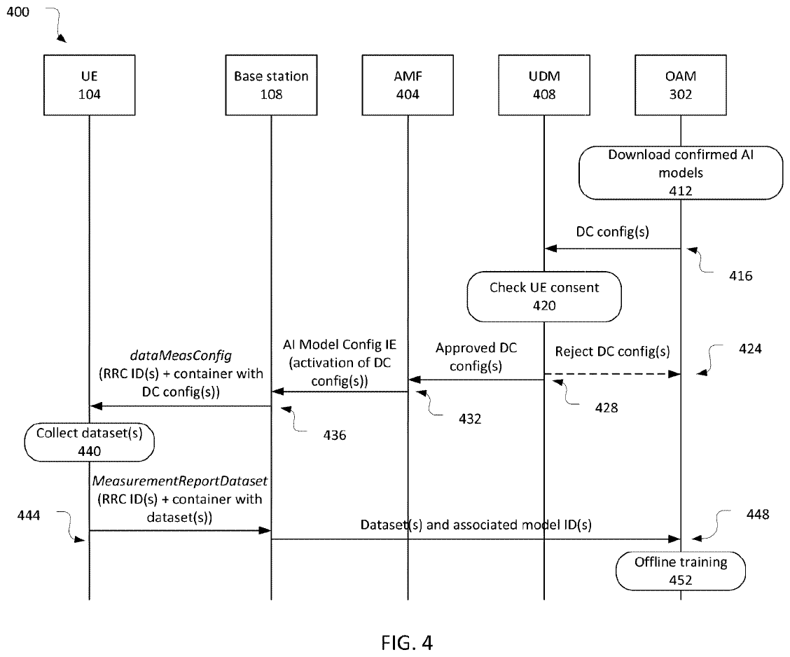

FIG. 4 illustrates a signaling procedure 400 that illustrates aspects of offline model training in accordance with some embodiments. The signaling procedure 400 may include signals between, and operations performed by, the UE 104, the base station 108, an access and mobility management function (AMF) 404, a unified data management function (UDM) 408, and the OAM 302. The AMF 404 and UDM 408 may be part of the core network 112.

The signaling procedure 400 may include the OAM 302 downloading confirmed AI models. The confirmed AI models may be similar to those described above with respect to the signaling procedure 300. The confirmed AI models may be downloaded from an application server in, for example, the external data network 120. Each AI model may require a specific dataset for training purposes. Different models may require different data sets. To facilitate the offline training, the OAM 302 may perform the following dataset reporting configuration procedure based on the confirmed AI models.

The OAM 302 may transmit data collection (DC) configuration(s) to the UDM 408 at 416. Each DC configuration may correspond to a confirmed AI model. In some embodiments, the DC configuration may be indicated in the message transmitted to the UDM 408 by a model ID. In other embodiments, the DCI configuration may be indicated by a DC configuration ID that is mapped to the model ID. A DC configuration may comprise a configuration of how to generate a dataset having training or inference data for a particular AI model. The format of the DC configuration may be an application-layer format that is a proprietary format or an open format.

The UDM 408 may check for UE consent at 420. The UE consent may indicate whether the UE 104 authorizes sharing of a dataset that corresponds to a particular DC configuration. The UE consent may be defined in user subscriber information. UE consent may be checked for each of the DC configuration(s). In the event the UE 104 does not consent to sharing datasets for one or more DC configurations, the UDM 408 may transmit a message to the OAM 302 with an indication of the rejected DC configurations at 424. In the event the UE 104 does consent to sharing data sets for one or more DC configurations, the UDM 408 may transmit a message to the AMF 404 with an indication of the approved DC configurations at 428.

Upon receiving the approved DC configurations, the AMF 404 may initiate activation of dataset management/reporting for the approved DC configurations. This may be done by the AMF 404 transmitting an AI model configuration information element (IE) with an indication of DC configurations to be activated at 432. The AI model configuration IE may be transmitted over an N2 interface. Each DC configuration may be uniquely identified by a model ID (or DC configuration ID). Dataset management/reporting may be activated for only one DC configuration or for a plurality of DC configurations simultaneously.

In some embodiments, the AI model configuration IE may be included in an INITIAL CONTEXT SETUP REQUEST used to establish a UE context or a UE CONTEXT MODIFICATION REQUEST that may be used to modified an established UE context. If the AI model configuration IE is included in the INITIAL CONTEXT SETUP REQUEST or the UE CONTEXT MODIFICATION REQUEST, the base station 108 may use it for AI model management if supported.

The base station 108 may generate a container with DC configurations that are to be activated and include the container in a new RRC message, for example, a data measurement configuration (dataMeasConfig) message. The dataMeasConfig message may be transmitted to the UE 104 at 436.

The DataMeasConfig message may also include an RRC ID corresponding to each DC configuration. The RRC ID may be uniquely mapped to the model ID. As the RRC ID does not need to be globally unique, as is the case with the model ID, it may be significantly shorter than the model ID.

In some instances, the DataMeasConfig message may also include a type of dataset, a configuration reporting (e.g., periodicity or trigger associated with reporting of datasets), and whether the dataset is RAN visible. The dataset type may be, for example, a measurement, a ground-truth label, or even different use cases (e.g., a dataset for CSI compression, a dataset for beam management, or a dataset for positioning). If the dataset is indicated as being visible tot he RAN, the base station 108 may be able to use the dataset directly. For example, a dataset corresponding to a CSI or beamforming use-case function may be visible to the base station 108; however, a dataset corresponding to a positioning use-case function may not be visible to the base station 108. The indications on which datasets are RAN visible may be provided by the OAM 302 or the AMF 404.

The dataMeasConfig message may be similar to dataMeasConfig 712 shown in the RRC messages 700 of FIG. 7 in accordance with some embodiments.

Upon receiving the DataMeasConfig message, the UE 104 may begin to collect dataset(s) associated with the activated DC configurations at 440. An application layer of the UE 104 may collect the dataset(s), which may then be encapsulated into a transparent container for transmission to the network. The UE 104 may transmit the container to the base station 108 in a new RRC message, for example, a measurement report dataset (MeasurementReportDataset) message. The MeasurementReportDataset message may also include the RRC ID(s) for the corresponding dataset(s). The MeasurementReportDataset message may include one dataset/RRC ID or a plurality of datasets/RRC IDs. The UE may transmit the MeasurementReportDataset message to the base station 108 at 444. The MeasurementReportDataset message may be similar to MeasurementReportDataset 716 shown in the RRC messages 700 of FIG. 7 in accordance with some embodiments.

Upon receiving the MeasurementReportDataset message, the base station 108 may forward the dataset(s) and associated model ID(s) to the OAM 302 at 448. The dataset(s) may then be used for offline training of associated AI models.

In some embodiments, the base station 108 may configure the UE 104 with an adjustment to the reporting of a particular DC configuration. For example, the base station 108 may configure the UE 104 to pause or resume reporting for a particular DC configuration. This may be done through RRC signaling.

Upon receiving the dataset(s) from the base station 108, the OAM 302 may perform offline training at 452.

In the event the OAM 302 desires a dataset from the base station 108 for offline training, it may acquire the dataset directly from the base station 108 without performing the signaling procedure 400.

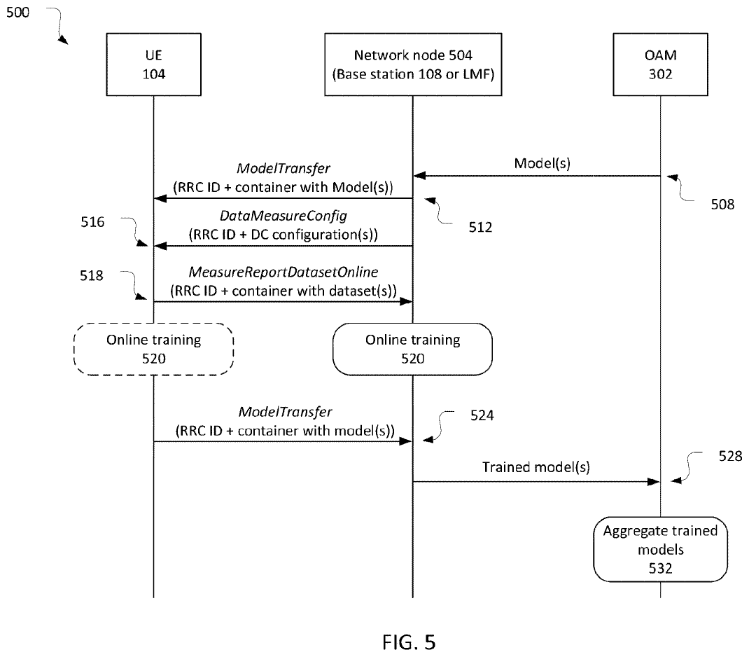

FIG. 5 illustrates a signaling procedure 500 that illustrates aspects of online model training in accordance with some embodiments. The signaling procedure 500 may include signals between, and operations performed by, the UE 104, a network node 504 and the OAM 302. The network node 504 may host/manage the AI model training. Depending on the use-case function, the network node 504 may be the base station 108 or an LMF of the core network 112.

The online training associated with the signaling procedure 500 may include a latency requirement that is more strict than the offline training associated with the signaling procedure 400. Thus, the online training may be performed closer to the point of data collection, for example, by the network node 504.

The signaling procedure 500 may include the OAM 302 sending one or more AI model(s) to the network node 504. In some embodiments, the model(s) may be model(s) trained by an offline training such as that described with respect to signaling procedure 400. In other embodiments, the model(s) may be untrained model(s). If the use-case function of the model(s) is for CSI compression or beam management, the OAM 302 may send the model(s) to the base station 108 and the base station 108 may forward the model(s) in a container of a new RRC message, for example, a model transfer (ModelTransfer) message at 512. If the use-case function is for positioning, the OAM 302 may send the model(s) to an LMF of the core network 112. At 512, the LMF may then forward the model(s) to the UE 104 using NAS signaling, which may be incorporated in a container of a new RRC message, e.g., the ModelTransfer message. The ModelTransfer message may also include RRC ID(s) that map to the model(s).

If data from the UE 104 is desired for online training, the signaling procedure 500 may include the network node 504 configuring the data collection by sending a DC configuration to the UE 104. The DC configuration may be sent in a DataMeasureConfig message at 516 along with RRC ID(s) that correspond to the DC configuration(s). The dataMeasConfig message at 516 may be similar to dataMeasConfig 712 shown in the RRC messages 700 of FIG. 7 in accordance with some embodiments.

For online training, the DC configuration(s) may be generated by the network node 504, in contrast to being generated by the OAM 302 as discussed above with respect to offline training. The UE 104 may report the dataset(s) collected based on the DC configuration(s) in a MeasureReportDatasetOnline message, at 518, that includes the RRC ID corresponding to the DC configuration(s) and a container with the dataset(s). This may be similar to that described above with respect to dataset reporting of the signaling procedure 400; however, in signaling procedure 500, the dataset delivery may be terminated by the network node 504 rather than the OAM 302. The MeasureReportDatasetOnline message may be similar to MeasureReportDatasetOnline 720 shown in the RRC messages 700 of FIG. 7 in accordance with some embodiments.

The signaling procedure 500 may include online training 520 by the UE 104 or the network node 504. If the model(s) are trained by the UE 104, the signaling procedure 500 may include transmitting the trained model(s) in a ModelTransfer message at 524. The ModelTransfer message may be an RRC message that includes RRC ID(s) along with a container that includes the model(s).

The ModelTransfer message at 512 or 524 may be similar to ModelTransfer 724 shown in the RRC messages 700 of FIG. 7 in accordance with some embodiments.

In some embodiments, the signaling procedure 500 may include the network node 504 transmitting the online-trained model(s) to the OAM 302 at 528. The OAM 302 may aggregate trained models received from a number of nodes of the network at 532.

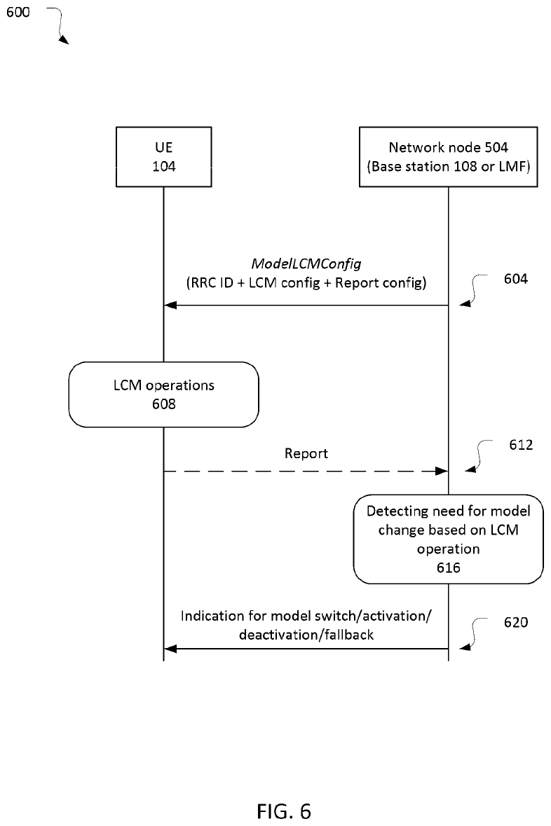

FIG. 6 illustrates a signaling procedure 600 that illustrates aspects of model inference and monitoring in accordance with some embodiments. The signaling procedure 600 may include signals between, and operations performed by, the UE 104 and the network node 504 and the OAM 302. The network node 504 may host/manage the model inference and monitoring in accordance with some embodiments.

The signaling procedure 600 may include, at 604, the network node 504 sending an RRC message, for example, a model LCM configuration (ModelLCMConfig) message, to the UE 104. The ModelLCMConfig message may include an RRC ID (or model/functionality ID), an LCM configuration, and a reporting configuration. The LCM configuration may provide an indication of how long the UE 104 is to monitor a particular model or DC configuration and provide feedback. The LCM configuration may provide instructions regarding model inferences, monitoring, activation, deactivation, fallback, or switches. The reporting configuration may provide instructions on how and when to feed back monitoring information. For example, the reporting configuration may configure periodic reporting by providing a reporting interval or may configure event-triggered reporting. With respect to the event-triggered reporting, the reporting configuration may configure, or otherwise activate, various thresholds that the UE 104 may use to detect whether an event exists that would trigger the report. The ModelLCMConfig message at 604 may be similar to ModelILCMConfig 728 of RRC messages 700 of FIG. 7 in accordance with some embodiments.

The signaling procedure 600 may further include, at 608, the UE 104 performing LCM operations based on the LCM configuration. In some embodiments, some or all of the LCM operations 608 may be The signaling procedure 600 may further include, at 612, the UE 104 sending a report to the network node 504. The report may be based on the reporting configuration. In some embodiments, the LCM operation may be performed by the network node 504 and the reporting may not be needed.

The RRC ID of the ModelLCMConfig may either correspond to a model ID or to a functionality ID. Whether to use model ID or the functionality ID depends on whether model-based LCM or functionality-based LCM is applied. Model-based LCM means that NW and UE 104 exchange model information via their model ID. The UE 104 applies the model according to model ID provided by NW. Functionality-based LCM means that NW and UE 104 exchange function information on AI (e.g. CSI or beam management). The UE 104 can choose which model to use among the models that are for one function (e.g. beam management).

The signaling procedure 600 may further include the network node 504 detecting, at 616, a need for a model change based on the LCM operation 608. Upon detecting the need, the network node 504 may transmit an indication for a model change to the UE 104 at 620. The model change may be a switch or fallback from a first model to a second model, an activation of a model, or a deactivation of a model.

In some embodiments, an AS level delta configuration may be applied. For example, the ModelLCMConfig message may include a plurality of RRC IDs/LCM configurations. In one example, the UE 104 may switch between the models corresponding to the configured RRC IDs when certain events are detected. In this manner, a model may be added or removed based on predetermined events. In another example, the UE 104 may switch between the models corresponding to the configured RRC IDs that are indicated by the base station 108. In this manner, a model may be added or removed according to an RRC reconfiguration from the base station 108.

In some embodiments, a new SRB may be used for various RRC messages described herein. The RRC messages may be any one of the RRC messages 700 of FIG. 7.

The new SRB may benefit from priority that is higher than a legacy SRB4. If the new SRB had a lower priority, its successful transmission may be prevented due to the potentially large payload size of the new SRB. However, the priority of the new SRB may be lower than SRB0/1 to prevent it from blocking transmission of a data radio bearer (DRB).

The priority of the new SRB may be provided based on one or more of the following options. In a first option, the priority may be configurable. For example, a configurable priority, similar to DRB, may be provided by the base station 108 transmitting a configuration to the UE 104 via RRC signaling. In a second option, a separate radio link control (RLC)/logical channel (LCH) in the existing SRB4 may be used for the new SRB. The new RLC/LCH may be provided a relatively high priority (e.g., the highest priority), while the existing RLC/LCH may be associated with a relatively low priority (e.g., the lowest priority).

Some embodiments may utilize a segmentation capability to allow transmission of large payload sizes that may be associated with one or more of the RRC messages 700. Existing downlink RRC message segmentation is AS segmentation, which has restriction with up to 5 segments (e.g., 45KB) because of limitation of AS layer buffer size. However, an application-layer buffer is much larger. Thus, one or more of the following options may be used for segmentation in accordance with some embodiments.

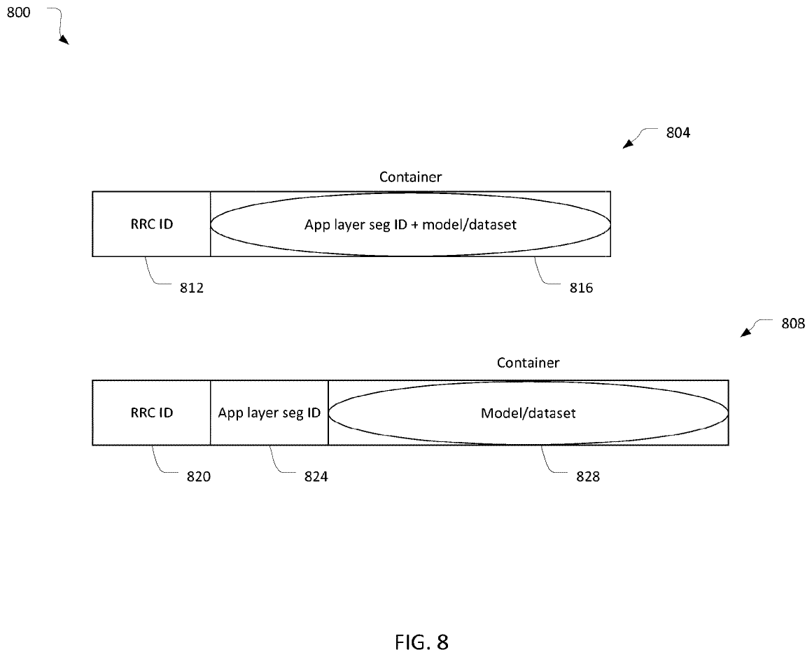

FIG. 8 includes segmented messages 800 that illustrate segmentation operation in accordance with some embodiments. The segmented messages 800 may include a first message 804 segmented in accordance with a first option and a second message 808 segmented in accordance with a second option.

In the first option, an application layer at the UE 104 or the OAM 302 may perform the segmentation and include a segment ID as part of an application ID (e.g., application layer segment ID) in container 816 with the model/dataset. The message 804 may also include an RRC ID 812 as discussed elsewhere herein.

In the second option, the application layer at the UE 104 or the OAM 302 may perform the segmentation and may provide the AS layer (at the UE 104 or the base station 108) with the application layer segment ID. The AS layer may then generate the message 808 to include the application layer segment ID 824 in an IE of a payload of the message 808. The message may further include the RRC ID 820 and the container 828 with the model/dataset.

Application segmentation may be utilized in conjunction with RRC segmentation.

In some embodiments, data compression may be applied to the RRC message transmitted by the new SRB to reduce a payload size. This may be especially useful if the RRC message is being used to transmit a large dataset. In some embodiments, a device may use a DEFLATE-based solution, consistent with Request For Comments (RFC) 1951 DEFLATE Compressed Data Format Specification, May 1996, to reduce the payload size.

In some embodiments, the UE 104 may transmit UE assistance information to provide an indication of a temporary reduction to AI model capabilities of the UE. The AI model capabilities may correspond to reporting, monitoring, data collection, or any other operations associated with training or using an AI model. For example, the UE 104 may indicate whether it is experiencing (or is no longer experiencing) overheating, memory shortage, a computation resource shortage, or a low-battery condition. It may be up to the network as to whether any action is taken in response to receiving the UE assistance information. In some embodiments, the network may reduce computational operations to be performed by the UE 104 in the event it has reduced AI model capabilities.

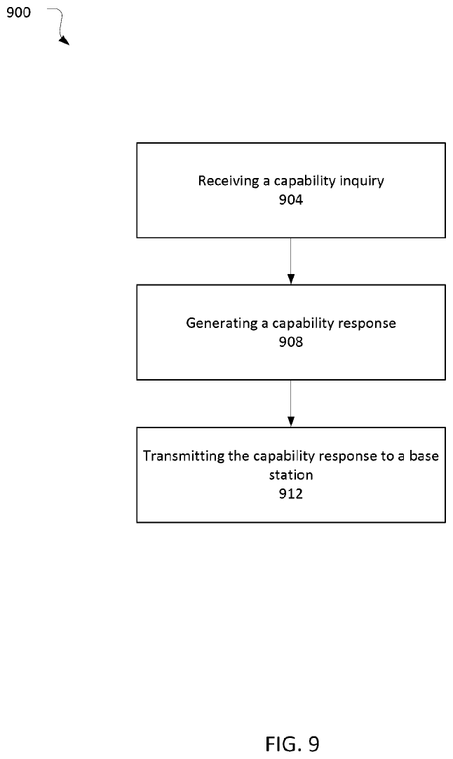

FIG. 9 provides an operation flow/algorithmic structure 900 in accordance with some embodiments. The operation flow/algorithmic structure 900 may be performed by a UE such as UE 104, UE 1200; or components thereof, for example, processors 1204.

The operation flow/algorithmic structure 900 may include, at 904, receiving a capability inquiry. The capability enquiry may be received from a base station and may request information regarding AI-model capabilities of the UE.

The operation flow/algorithmic structure 900 may further include, at 908, generating a capability response. The capability response may indicate an AI model supported by the UE for a use case function.

The operation flow/algorithmic structure 900 may further include, at 912, transmitting the capability response to a base station.

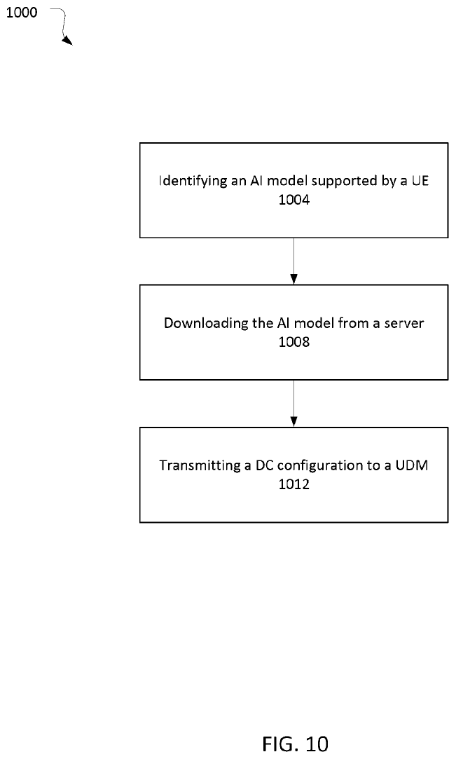

FIG. 10 provides an operation flow/algorithmic structure 1000 in accordance with some embodiments. The operation flow/algorithmic structure 1000 may be performed by an OAM such as OAM 302 or network node 1300; or components thereof, for example, processors 1304.

The operation flow/algorithmic structure 1000 may include, at 1004, identifying an AI model supported by a UE. The AI model supported by the UE may be identified based on capability reporting received from the UE.

The operation flow/algorithmic structure 1000 may further include, at 1008, downloading the AI model from a server. The server may reside in an external data network.

The operation flow/algorithmic structure 1000 may further include, at 1012, transmitting a DC configuration to a UDM. The DC configuration may be associated with the AI model downloaded from the server. The UDM may determine whether the UE has consented to sharing data based on the DC configuration. If so, an approved DC configuration may be forwarded to the UE. If not, a rejected DC configuration may be provided to the OAM.

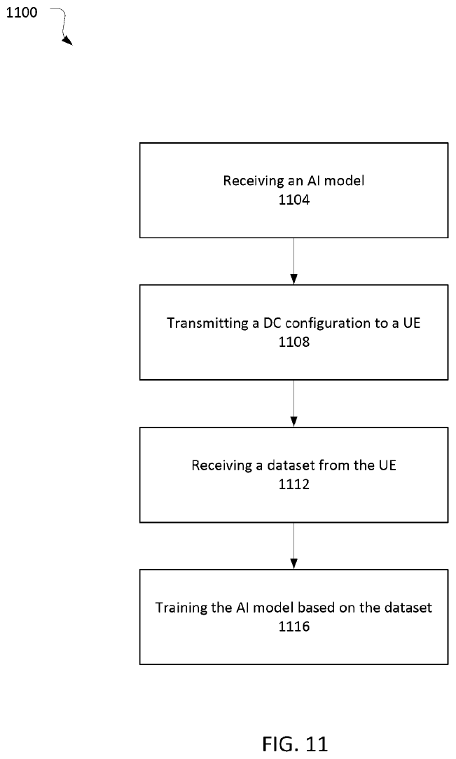

FIG. 11 provides an operation flow/algorithmic structure 1100 in accordance with some embodiments. The operation flow/algorithmic structure 1100 may be performed by a network node such as OAM 302, network node 504, or network node 1300; or components thereof, for example, processors 1304.

The operation flow/algorithmic structure 1100 may include, at 1104, receiving an AI model supported by a UE. The AI model supported by the UE may be identified based on capability reporting received from the UE.

The operation flow/algorithmic structure 1100 may further include, at 1108, transmitting a DC configuration to a UE. The DC configuration may be associated with the AI model.

The operation flow/algorithmic structure 1100 may further include, at 1112, receiving a dataset from the UE. The dataset may be collected by the UE based on the DC configuration.

The operation flow/algorithmic structure 1100 may further include, at 1116, training the AI model based on the dataset. In some embodiments, the training may be offline training performed by an OAM. In other embodiments, the training may be online training performed by a base station or LMF.

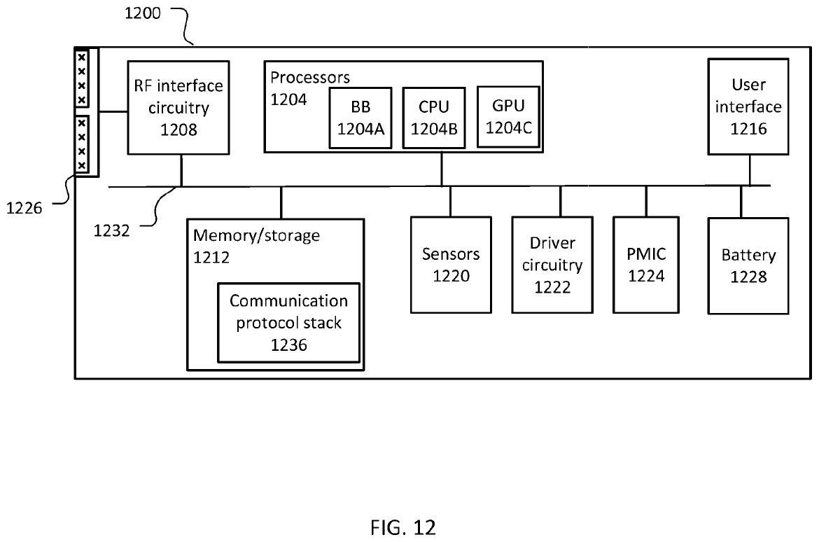

FIG. 12 illustrates an example UE 1200 in accordance with some embodiments. The UE 1200 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 1200 may include processors 1204, RF interface circuitry 1208, memory/storage 1212, user interface 1216, sensors 1220, driver circuitry 1222, power management integrated circuit (PMIC) 1224, antenna structure 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1232, which may represent any type of interface, input/output, bus (local, system, or expansion), transmission line, trace, optical connection, etc. that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations of the UE with respect to AI models as described herein.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various operations described herein. The memory/storage 1212 include any type of volatile or non-volatile memory that may be distributed throughout the UE 1200. In some embodiments, some of the memory/storage 1212 may be located on the processors 1204 themselves (for example, L1 and L2 cache), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1226.

In various embodiments, the RF interface circuitry 1208 may be configured to transmit/receive signals in a manner compatible with NR access technologies.

The antenna structure 1226 may include antenna elements to convert electrical signals into radio waves to travel through the air and to convert received radio waves into electrical signals. The antenna elements may be arranged into one or more antenna panels. The antenna structure 1226 may have antenna panels that are omnidirectional, directional, or a combination thereof to enable beamforming and multiple-input, multiple-output communications. The antenna structure 1226 may include microstrip antennas, printed antennas fabricated on the surface of one or more printed circuit boards, patch antennas, phased array antennas, etc. The antenna structure 1226 may have one or more panels designed for specific frequency bands including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1200.

The sensors 1220 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of the sensors 1220 and control and allow access to the sensors 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

In some embodiments, the PMIC 1224 may control, or otherwise be part of, various power saving mechanisms of the UE 1200. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1200 may power down for brief intervals of time and thus save power. If there is no data traffic activity for an extended period of time, then the UE 1200 may transition off to an RRC_Idle state, where it disconnects from the network and does not perform operations such as channel quality feedback, handover, etc. The UE 1200 goes into a very low power state and it performs paging where again it periodically wakes up to listen to the network and then powers down again. The UE 1200 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1228 may power the UE 1200, although in some examples the UE 1200 may be mounted or deployed in a fixed location, and may have a power supply coupled to an electrical grid. The battery 1228 may be a lithium-ion battery or a metal-air battery such as a zinc-air battery, an aluminum-air battery, a lithium-air battery, and the like. In some implementations, such as in vehicle-based applications, the battery 1228 may be a typical lead-acid automotive battery.

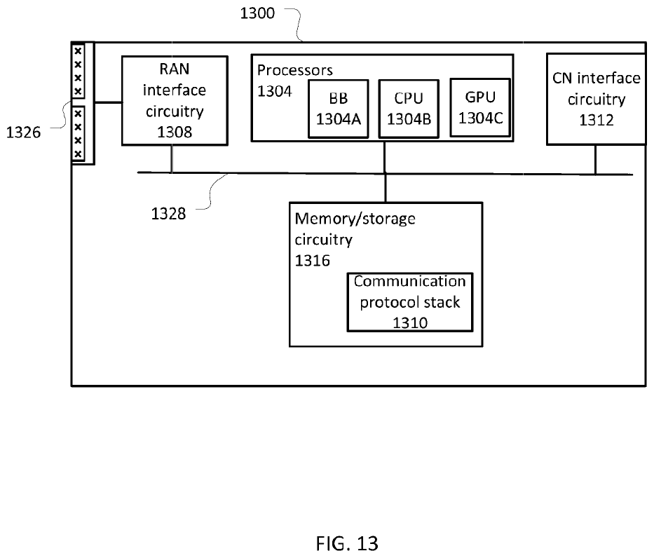

FIG. 13 illustrates an example network node 1300 in accordance with some embodiments. The network node 1300 may be a base station, LMF, OAM, AMF, or UDM as described elsewhere herein. The network node 1300 may include processors 1304, RF interface circuitry 1308, core network (CN) interface circuitry 1312, memory/storage circuitry 1316, and antenna structure 1326. The RF interface circuitry 1308 and antenna structure 1326 may not be included when the network node 1300 is an AMF.

The components of the network node 1300 may be coupled with various other components over one or more interconnects 1328.

The processors 1304, RF interface circuitry 1308, memory/storage circuitry 1316 (including communication protocol stack 1310), antenna structure 1326, and interconnects 1328 may be similar to like-named elements shown and described with respect to FIG. 12.

The processors 1304 may executed instructions to cause the network node 1300 to perform operations such as those described with respect to the AI-model operations of the base station, LMF, OAM, AMF, or UDM described elsewhere herein.

The CN interface circuitry 1312 may provide connectivity to a core network, for example, a 5th Generation Core network (5GC) using a 5GC-compatible network interface protocol such as carrier Ethernet protocols, or some other suitable protocol.

Network connectivity may be provided to/from the network node 1300 via a fiber optic or wireless backhaul. The CN interface circuitry 1312 may include one or more dedicated processors or FPGAs to communicate using one or more of the aforementioned protocols. In some implementations, the CN interface circuitry 1312 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further exemplary embodiments are provided.

Example 1 includes a method to be implemented by a user equipment (UE), the method comprising: receiving, from a base station, a capability inquiry; generating, based on the capability inquiry, a capability response to indicate an artificial intelligence (AI) model supported by the UE for a use-case function; and transmitting the capability response to the base station.

Example 2 includes the method of example 1 or some other example herein, wherein the capability response is to indicate one or more AI models supported by the UE per use-case function; or is to indicate one or more use-case functions supported by the UE per AI model.

Example 3 includes the method of example 1 or some other example herein, further comprising: generating a radio-resource configuration (RRC) message that includes a container with an identifier associated with the AI model or the use-case function; and transmitting the RRC message to the base station, wherein the identifier is to be forwarded to an operations, administration, and maintenance (OAM) node for the OAM node to train the AI model for the use-case function.

Example 4 includes the method of example 3 or some other example herein, wherein the identifier is a first identifier associated with the AI model and the RRC message further includes a second identifier associated with the use-case function.

Example 5 includes the method of example 3 or some other example herein, further comprising: determining the identifier is associated with the AI model based on a configuration from a manufacturer of the UE or based on signaling from a public land mobile network (PLMN), wherein the identifier is a globally-unique identifier.

Example 6 includes the method of example 3 or some other example herein, wherein the AI model is a first AI model, a second AI model is associated with the use-case function, the identifier is a first identifier associated with the first AI model and the RRC message further includes a second identifier associated with the second AI model.

Example 7 includes the method of example 3 or some other example herein, wherein the identifier is an identifier of the AI model, the RRC message is a first RRC message, the container is a first container, and the method further comprises: receiving, from the base station, a second RRC message that includes a second container with the identifier of the AI model to confirm that the OAM node supports the AI model.

Example 8 includes the method of example 1 or some other example herein, further comprising: transmitting, to the base station, assistance information to provide an indication with respect to a reduced AI model capability of the UE.

Example 9 includes the method of example 8 or some other example herein, wherein the indication corresponds to whether the UE is experiencing overheating, memory shortage, computation resource shortage, or a low battery condition.

Example 10 includes the method of example 8 or some other example herein, further comprising: transmitting the assistance information in an RRC message or in uplink control information.

Example 11 includes a method to be implemented by an operations, administration, and maintenance (OAM) node, the method comprising: identifying an artificial intelligence (AI) model supported by a user equipment (UE); downloading the AI model from a server; and transmitting, to a unified data management (UDM) function of a core network, an identifier of a data collection configuration associated with the AI model to determine whether the UE authorizes sharing of a dataset based on the data collection configuration.

Example 12 includes the method of example 11 or some other example herein, further comprising: confirming the AI model is supported by the OAM node; and sending, to the UE, a confirmed model identifier (ID) associated with the AI model.

Example 13 includes the method of example 11 or some other example herein, further comprising: a response, from the UDM, to indicate the UE does not authorize sharing of the dataset based on the data collection configuration.

Example 14 includes the method of example 11 or some other example herein, further comprising: generating a container to include one or more identifiers respectively associated with one or more data collection configurations, wherein the one or more identifiers includes the identifier and the one or more data collection configurations include the data collection configuration, wherein said transmitting the identifier includes transmitting the container.

Example 15 includes the method of example 11 or some other example herein, further comprising: receiving, from the UE via a base station, a dataset corresponding to the data collection configuration, wherein the dataset is transmitted to the base station in a container of a radio resource control (RRC) message; and training the AI model based on the dataset to generate a trained AI model.

Example 16 includes the method of example 15 or some other example herein, wherein the AI model is associated with channel state information (CSI) compression or beam management and the method further comprises: sending the trained AI model to the UE via a base station.

Example 17 includes the method of example 15 or some other example herein, wherein the AI model is associated with UE positioning and the method further comprises: sending the trained AI model to the UE via a location management function (LMF).

Example 18 includes a method to be implemented by a unified data management (UDM) function, the method comprising: receiving, from an operations, administration, and maintenance (OAM) node, an identifier of a data collection configuration associated with an artificial intelligence (AI) model; determining whether a user equipment (UE) authorizes sharing of a dataset associated with the data collection configuration; and transmitting a message to the OAM or to an access and mobility management function (AMF) based on said determining whether the UE authorizes sharing of the dataset.

Example 19 includes the method of example 18 or some other example herein, wherein determining whether the UE authorizes sharing of the dataset comprises determining the UE authorizes sharing of the dataset and the method further comprises: transmitting the message to an AMF to activate the data collection configuration.

Example 20 include a method to be implemented in a base station, the method comprising: receiving an artificial intelligence (AI) model configuration information element (IE) with an identifier of data collection configuration associated with an AI model supported by a user equipment (UE); and transmitting a radio resource control (RRC) message to the UE with the AI model configuration IE to activate the data collection configuration at the UE.

Example 21 includes the method of example 20 or some other example herein, wherein the RRC message further includes an RRC identifier that is associated with a globally-unique identifier of the AI model, Example 22 includes the method of example 20 or some other example herein, further comprising: receiving the AI model configuration IE over an N2 interface, wherein the RRC message is a data measurement configuration message.

Example 23 includes the method of example 20 or some other example herein, wherein the RRC message further indicates a type of dataset, a reporting configuration, or whether the data collection configuration is visible to a radio access network (RAN).

Example 24 includes the method of example 20 or some other example herein, further comprising: receiving, from the UE, a measurement report dataset RRC message that includes a container with a dataset collected by the UE based on the data collection configuration.

Example 24 includes the method of example 24 or some other example herein, further comprising: forwarding the dataset with an identifier of the AI model to an operations, administration, and maintenance (OAM) function.

Example 26 include a method of operating a network node, the method comprising: receiving, from an operation, administration, and maintenance (OAM) node, an artificial intelligence (AI) model; generating a data measurement configuration (DataMeasureConfig) message with a radio resource control (RRC) identifier and a container with a data collection (DC) configuration associated with the AI model; transmitting the DataMeasureConfig message to a user equipment (UE); receiving, from the UE, a dataset collected based on the DC configuration; and performing an online training of the AI model based on the dataset.

Example 27 includes the method of example 26 or some other example herein, wherein the AI model is a first AI model and the method further comprises: generating a first model transfer (ModelTransfer) message with a radio resource control (RRC) identifier and a container with the first AI model or a second AI model; and transmitting the ModelTransfer message to the UE; and receiving, from the UE, a second ModelTransfer message with the RRC identifier and a trained AI model corresponding to the first AI model or the second AI model.

Example 28 includes the method of example 26 or some other example herein, wherein the network node is a base station or a location management function.

Example 29 includes a method to be implemented by a user equipment, the method comprising: receiving, from a network node, a model lifecycle management configuration (ModelLCMConfig) message that includes a radio resource identifier associated with an artificial intelligence (AI) model and a lifecycle management (LCM) configuration; and performing an LCM operation based on the LCM configuration.

Example 30 includes the method of example 29 or some other example herein, wherein the LCM configuration is to configure an LCM operation comprising: model inference, monitoring, activation, deactivation, fallback, or switch, and the method further comprises: performing the LCM operation based on the LCM configuration.

Example 31 includes the method of example 30 or some other example herein, further comprising: transmitting, to the network node, a report based on said performing of the LCM operation.

Example 32 includes the method of example 29 or some other example herein, further comprising: receiving, from the network node, an indication to perform a model change, wherein the model change is a switch, activation, deactivation, or fallback; and performing the model change.

Example 33 includes a method to be implemented by a network node, the method comprising: generating a radio resource control (RRC) message to include a container having an artificial intelligence (AI) model identifier (ID), a use-case function ID corresponding to a use-case function of an AI model, a data-collection (DC) configuration of an AI model; a dataset associated with an AI model, an AI model, or a lifecycle management (LCM) configuration associated with an AI model; and transmitting the RRC message via a signaling radio bearer (SRB).

Example 34 includes the method of example 33 or some other example herein, wherein the SRB includes a priority configured to be higher than an SRB4 priority and lower than an SRB0/1 priority.

Example 35 includes the method of example 34 or some other example herein, wherein the priority is configured by a base station using RRC signaling.

Example 36 includes the method of example 33 or some other example herein, wherein the SRB is an SRB4 and the method further comprises: transmitting the RRC message in a first radio link layer (RLC) or logical channel (LCH) of an SRB4 that is associated with a first priority that is higher that a second priority of a second RLC or LCH of the SRB4.

Example 37 includes the method of example 33 or some other example herein, wherein the RRC message includes an application layer segment identifier inside of the container or outside of the container.

Example 38 includes the method of example 33 or some other example herein, further comprising: applying data compression to data within the container.

Another example may include an apparatus comprising means to perform one or more elements of a method described in or related to any of examples 1-38, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-38, or any other method or process described herein.

Another example may include an apparatus comprising logic, modules, or circuitry to perform one or more elements of a method described in or related to any of examples 1-38, or any other method or process described herein.

Another example may include a method, technique, or process as described in or related to any of examples 1-38, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-38, or portions thereof.

Another example may include a signal as described in or related to any of examples 1-38, or portions or parts thereof.

Another example may include a datagram, information element, packet, frame, segment, PDU, or message as described in or related to any of examples 1-38, or portions or parts thereof, or otherwise described in the present disclosure.

Another example may include a signal encoded with data as described in or related to any of examples 1-38, or portions or parts thereof, or otherwise described in the present disclosure.

Another example may include a signal encoded with a datagram, IE, packet, frame, segment, PDU, or message as described in or related to any of examples 1-38, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-38, or portions thereof.

Another example may include a computer program comprising instructions, wherein execution of the program by a processing element is to cause the processing element to carry out the method, techniques, or process as described in or related to any of examples 1-38, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-25. (canceled)

26. A method comprising:
receiving, from a base station, a capability inquiry; and
generating, for transmission to the base station and based on the capability inquiry, a capability response to indicate an artificial intelligence (AI) model supported by a user equipment (UE) for a use-case function.

27. The method of claim 26, wherein the capability response is to indicate:
one or more AI models supported by the UE per use-case function; or one or more use-case functions supported by the UE per AI model.

28. The method of claim 26, further comprising:
generating, for transmission to the base station, a radio-resource configuration (RRC) message that includes a container with an identifier associated with the AI model or the use-case function, wherein the identifier is to be forwarded to an operations, administration, and maintenance (OAM) node for the OAM node to train the AI model for the use-case function.

29. The method of claim 28, wherein the identifier is a first identifier associated with the AI model and the RRC message further includes a second identifier associated with the use-case function.

30. The method of claim 28, further comprising:
determining the identifier is associated with the AI model based on a configuration from a manufacturer of the UE or based on signaling from a public land mobile network (PLMN), wherein the identifier is a globally-unique identifier.

31. The method of claim 28, wherein the AI model is a first AI model, a second AI model is associated with the use-case function, the identifier is a first identifier associated with the first AI model and the RRC message further includes a second identifier associated with the second AI model.

32. The method of claim 28, wherein the identifier is an identifier of the AI model, the RRC message is a first RRC message, wherein the container is a first container, and wherein the method further comprises:
receiving, from the base station, a second RRC message that includes a second container with the identifier of the AI model to confirm that the OAM node supports the AI model.

33. The method of claim 26, further comprising:
generating, for transmission to the base station, assistance information to provide an indication with respect to a reduced AI model capability of the UE.

34. The method of claim 33, wherein the indication corresponds to whether the UE is experiencing overheating, memory shortage, computation resource shortage, or a low battery condition.

35. The method of claim 33, wherein the assistance information is transmitted in a radio resource control (RRC) message or in uplink control information.

36. A method comprising:
identifying an artificial intelligence (AI) model supported by a user equipment (UE);
downloading the AI model from a server; and
generating, for transmission to a unified data management (UDM) function of a core network, an identifier of a data collection configuration associated with the AI model to determine whether the UE authorizes sharing of a dataset based on the data collection configuration.

37. The method of claim 36, further comprising:
confirming the AI model is supported by an operations, administration, and maintenance (OAM) node; and
generating, for transmission to the UE, a container with at least one confirmed model identifier (ID) associated with the AI model.

38. The method of claim 36, further comprising:
identifying a response, from the UDM, that indicates that the UE does not authorize sharing of the dataset based on the data collection configuration.

39. The method of claim 36, further comprising:
generating a container to include at least one identifier respectively associated with at least one data collection configuration, wherein the at least one identifier includes the identifier and the at least one data collection configuration includes the data collection configuration, wherein the identifier is transmitted via the container.

40. The method of claim 36, further comprising:
receiving, from the UE via a base station, a dataset corresponding to the data collection configuration, wherein the dataset is transmitted to the base station in a container of a radio resource control (RRC) message; and
training the AI model based on the dataset to generate a trained AI model.

41. The method of claim 40, wherein the AI model is associated with channel state information (CSI) compression or beam management and the method further comprises:
generating, for transmission to the UE via the base station, a transmission including the trained AI model.

42. The method of claim 40, wherein the AI model is associated with UE positioning and the method further comprises:
generating, for transmission to the UE via a location management function (LMF), a transmission including the trained AI model.

43. An apparatus comprising:
processing circuitry to:
receive, from an operations, administration, and maintenance (OAM) node, an identifier of a data collection configuration associated with an artificial intelligence (AI) model;
determine whether a user equipment (UE) authorizes sharing of a dataset associated with the data collection configuration; and
generating, for transmission to the OAM or to an access and mobility management function (AMF), a message based on said determining whether the UE authorizes sharing of the dataset; and
interface circuitry coupled with the processing circuitry, the interface circuitry to enable communication.

44. The apparatus of claim 43, wherein to determine whether the UE authorizes sharing of the dataset comprises to determine the UE authorizes sharing of the dataset, and wherein the message is transmitted to the AMF to activate the data collection configuration.

45. The apparatus of claim 43, wherein whether the UE authorizes sharing of the dataset is determined based at least in part on user subscriber information associated with the UE.
